(19) United States
(12) Patent Application Publication
(10) Pub. No.: US 2026/0289426 A1
(43) Pub. Date: Sep. 24, 2026

(54) ACTIVE TESTING FOR GENERATIVE MODELS THROUGH RELATIVE ENTROPY-BASED SAMPLING

(71) Applicant: Optum, Inc., Minnetonka, MN (US)

(72) Inventors: Aashish Anantha RAMAKRISHNAN, State College, PA (US); Ardavan SAEEDI, Jersey City, NJ (US); Fazlolah MOHAGHEGH, Frisco, TX (US); Hamid Reza HASSANZADEH, Germantown, MD (US); Jagadish VENKATARAMAN, Menlo Park, CA (US)

(21) Appl. No.: 19/231,970

(22) Filed: Jun. 9, 2025

Related U.S. Application Data
(60) Provisional application No. 63/774,363, filed on Mar. 19, 2025.

(51) Int. Cl. G06N 20/20

(52) U.S. Cl. CPC G06N 20/20

(57) ABSTRACT

Various embodiments of the present disclosure provide an active testing technique that improves the functionality of a computer in various aspects. The techniques comprise receiving, using a generative model set, a set of classification outputs for an unlabeled data point within a training dataset. The techniques comprise generating, using a relative entropy function, a relative entropy value for the unlabeled data point based on a confidence value associated with a first and second classification output. The techniques comprise storing the unlabeled data point within a probability distribution based on the relative entropy value and then generating an annotated dataset by sampling the unlabeled data point from the probability distribution. The techniques may comprise initiating a training operation for a target model based on the annotated dataset.

### CROSS REFERENCE TO RELATED PARAGRAPHS

This application claims priority to U.S. Provisional Application No. 63/774,363, entitled “Generative Active Testing: Uncertainty-Aware Sampling Using Language Models”, filed Mar. 19, 2025, the entirety of which is incorporated by reference herein for all purposes.

### BACKGROUND

In various domains, generative models, such as large language models, have traditionally required substantial amounts of high-quality labeled data for benchmarking, and training, on tasks like question answering. However, obtaining annotations, especially for domain-specific applications, may be time-consuming, expensive, and resource intensive. This creates challenges for efficiently evaluating model performance, in addition to other downstream tasks, such as model training, when working with limited annotation resources whether automated or manual.

Conventional approaches for selecting test or training data relies on random sampling techniques. While straightforward to implement, these techniques may not effectively capture the full distribution of the dataset or identify the most informative samples for assessing model capabilities. Additionally, they may result in high variance when different subsets are used for evaluation.

Some techniques have attempted to incorporate model uncertainty estimates into the sample selection process. However, these approaches have typically focused on supervised learning tasks like classification and regression, rather than generative tasks such as open-ended question answering. There remains a need for improved methods to prioritize the labeling of samples that contribute most to validating model performance across the full test distribution.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a dataflow diagram of an active testing scheme in accordance with some embodiments of the present disclosure.

FIG. 5 is a dataflow diagram of an active testing scheme in accordance with some embodiments of the present disclosure.

FIG. 6 is a flowchart diagram of an example active testing process in accordance with some embodiments of the present disclosure

### DETAILED DESCRIPTION

Various embodiments of the present disclosure provide active testing schemes that improve the functionality of a computer with respect to various computing tasks, including machine learning training and evaluation. To do so, some embodiments of the present disclosure provide an active testing framework that implements a two-stage sampling approach for sampling data points from a training dataset. The two-stage sampling approach of the present disclosure improves upon traditional data sampling approaches by sampling datapoints that more directly mirror a true population of data points within a training dataset, rather than the majority population towards which traditional sampling techniques, such as random sampling, are inherently biased towards. At a first stage of the two-stage sampling approach, unlabeled data points within a training dataset are converted to classification prompts and input to a varied set of generative models to receive multiple classification outputs across generative models of different model structures. At a second stage, confidence scores for each of the classification outputs are synthesized, across model structures, to generate model-agnostic uncertainty measures (e.g., relative entropy values). These measures may be mapped to a probability distribution to support the model agnostic sampling of data points from a training dataset. In this manner, the two-stage sampling approach may blend measurements from different model structures to reduce biases traditionally introduced by performance deviations specific to different model structures. This, in turn, enables generalized data sampling for effectively evaluating (and/or training) machine learning models based on their performance and regardless of their specific structural characteristics.

More particularly, some embodiments of the present disclosure provide an active testing scheme for evaluating and/or training generative models for various generative tasks, including open ended question answering tasks. To address challenges in evaluating generative tasks like question answering, the first stage of the two stage sampling approach may incorporate a statement adaptation process. For example, for question-answering tasks, the statement adaptation process may convert multi-dimensional or open ended questions, such as a multiple choice question, into a deterministic statement using an answer from a generative model (e.g., regardless of the veracity of the answer). Using the deterministic statement, the two stage sampling approach may convert a question answering task to a deterministic classification task that may be evaluated consistently across multiple generative models. By doing so, the statement adaptation process may convert open ended questions into classification tasks that standardize the meaning of choices across different questions. By reformulating the task, the statement adaptation process enables the application of established entropy measurement techniques developed for classification tasks to generative question answering scenarios. This, in turn, allows for more accurate comparisons of model uncertainty across diverse question types, domains, and model structures.

In some embodiments, the present disclosure provides a model agnostic measurement scheme to complement the first stage of the two stage sampling approach with a second, acquisition stage during which multiple generative models may contribute to the evaluation of a data point. For example, at the second stage, an acquisition function (e.g., a relative entropy function) may be used to determine the model's confidence (e.g., a relative entropy) in its scores for a data point. To increase the diversity of samples, the confidence scores may be determined as the relative entropy between two or more generative models of different model structures. This multi-model approach enhances the diversity of selected samples, capturing a wider variety of error types or patterns in model predictions. For example, by computing relative entropy between the outputs of two models with different structures, the acquisition function may prioritize data points where both models exhibit uncertainty, leading to a more robust and representative annotated dataset. This, in turn, addresses limitations, such as bias, of single-model approaches that traditionally fail to capture the full spectrum of model behaviors across different architectures.

In some embodiments, the relative entropy scores of various data points within an initial dataset may be mapped within a probability distribution to support improved sampling techniques within an active testing framework. Data points, for example, may be sampled from the probability distribution with uncertain samples favored over more certain samples to create a model-agnostic annotated dataset. By enabling the creation of model-agnostic annotated datasets, the techniques of the present disclosure may facilitate more accurate performance assessment (and subsequent training) of various generative models. The approach ensures that the annotated dataset accurately models the true population distribution rather than being biased towards majority cases, which is a common pitfall of traditional sampling methods. By doing so, the techniques of the present disclosure improve annotated dataset quality, which may lead to more reliable benchmarking of generative models, enabling better model selection and refinement for specific tasks and domains.

Examples of technologically advantageous embodiments of the present disclosure provide modification to traditional sampling approaches to improve machine learning model training and benchmarking, among other aspects of the present disclosure. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

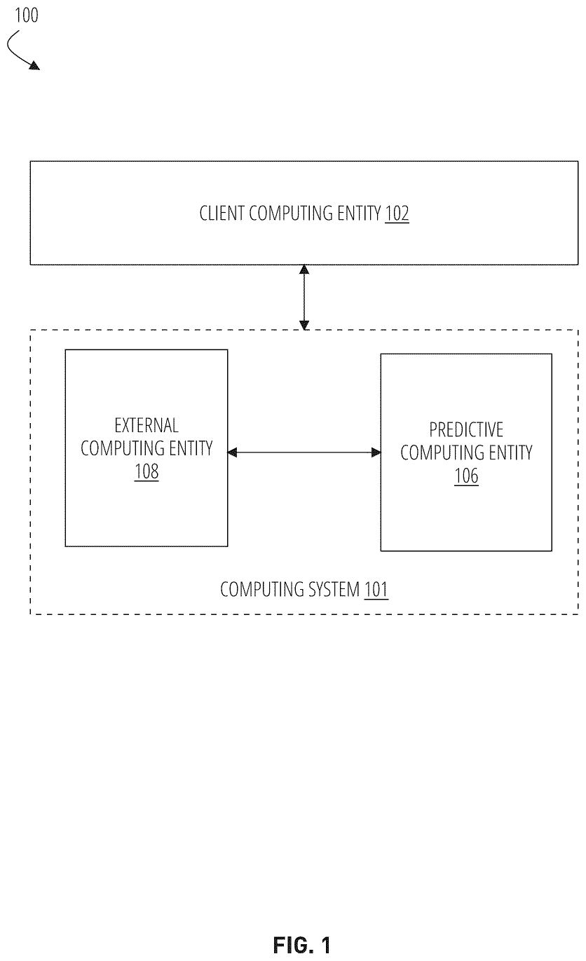

FIG. 1 is a block diagram of an example architecture 100 in accordance with some embodiments of the present disclosure. The architecture 100 comprises a computing system 101 configured to receive a request, such as a data sampling request, and/or the like, from client computing entities 102, process the request, and provide the responses to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a data sampling mechanism that may collectively process a training dataset, and/or the data points therein, using combinations of generative models. Some techniques of the present disclosure may adapt traditional models to a parallel processing framework for more accurately assessing the impact of data points on a generative process.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data sampling, model training, model benchmarking techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as training datasets, annotated datasets, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

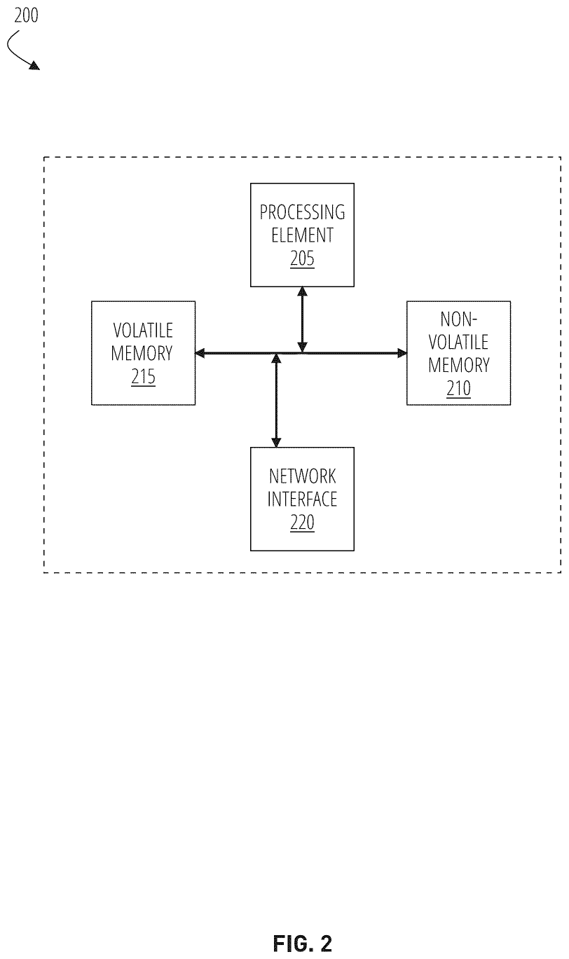

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

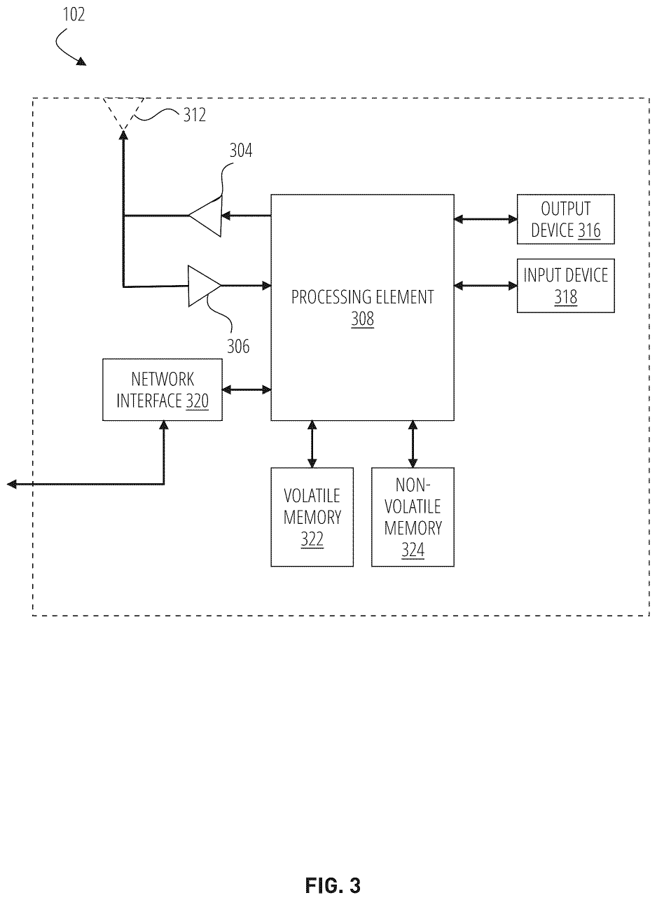

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality, including machine learning model evaluation and training. In particular, systems and methods are disclosed herein that implement data sampling and machine learning approaches to improve the generalizability, accuracy, and efficiency of evaluation dataset. By doing so, the data sampling and machine learning approaches of the present disclosure enable improved machine learning model evaluation and training processes that, when executed on a computer, improve various generative process. This, in turn, may improve the functionality of a computer with respect to various computing tasks, including data security, machine learning training, network communication, and the like.

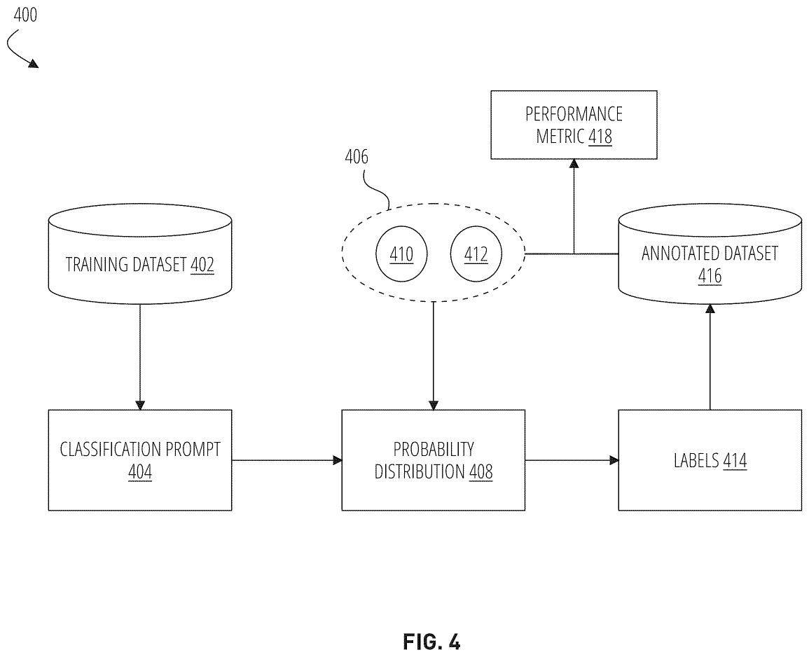

FIG. 4 is a dataflow diagram of an active testing scheme 400 in accordance with some embodiments of the present disclosure. A computing system, such as the computing system 101, may execute the active testing scheme 400 to address training and evaluation challenges with generative models. To do so, the computing system 101, and/or another system, may implement a confidence-based data sampling pipeline to sample datapoints from a training dataset 402 that are representative of true, model-agnostic population, rather than majority, model-specific population. Unlike traditional sampling mechanisms, such as random sampling, that sample from a majority population, the active testing scheme 400 reduces majority biases within an annotated dataset 416 by mapping data points to a probability distribution 408 based on metrics from multiple models within a generative model set 406. In this way, the active testing scheme 400 improves the distribution of an annotated dataset, which, in turn, enables more comprehensive training and evaluation operations that improve generative models (e.g., in terms of bias control, accuracy).

In some embodiments, the computing system 101 receives an unlabeled data point from a training dataset 402. The training dataset 402 may comprise a set of data that is aggregated, stored, or accessed for the purposes of training or evaluating a machine learning model, such as one of a generative model set 406. In some examples, the training dataset 402 may comprise a set of data points. The set of data points may comprise a set of unlabeled data points that may be annotated to facilitate a supervised, semi-supervised, reinforcement learning, active testing, or any other training process.

In some embodiments, the training dataset 402 comprises a structured collection of data samples. The training dataset 402, for example, may comprise a database (e.g., graph database, relational database), distributed file system, and/or the like. The training dataset 402, and/or unlabeled data points therein, may comprise one or more different data types such as text, numerical values, categorical labels, and/or more the like. For example, the training dataset 402 may be domain specific. In a healthcare domain, for example, the training dataset 402 may comprise a set of healthcare questionaries, medical claims, and/or other datapoints that may be reflective of a state within a healthcare environment. As another example, in a computer security domain, the training dataset 402 may comprise computer logs, vulnerability scans, and/or other datapoints that may be reflective of a state within a computer environment.

In any domain, the training dataset 402 may serve as the initial pool of unlabeled data points from which the active testing scheme 400 may sample candidates for annotation. Using the techniques of the present disclosure, the active testing scheme 400 may strategically sample datapoints from the training dataset 402 to create a high-quality annotated subset, the annotated dataset 416, that is most informative for evaluating and improving a target model's performance. In some examples, the training dataset 402 may be updated over time, for example through online learning approaches, where a target model may be continuously updated as new data becomes available, or federated learning, where the training data remains distributed across multiple sources while still contributing to model improvement. In addition, or alternatively, synthetic data generation techniques may be employed to augment the training dataset 402 with artificially created samples that help address specific challenges or underrepresented cases.

In some embodiments, an unlabeled data point comprises a data entry, data point, node, and/or the like within the training dataset 402 that associates a unit of raw or preprocessed input data for a generative model of the generative model set 406. An unlabeled data point, for example, may comprise a structured data object, record within a database or data storage system, node within a graph data structure, and/or the like. Depending on the specific task and/or domain, an unlabeled data point may comprise one or more different types of information, such as text, numerical features, references to other data sources, and/or the like. In a healthcare domain, for example, an unlabeled data point may comprise a healthcare question given a particular context, such as an electronic health record or medical claim. As another example, in a computer security domain, an unlabeled data point may comprise a virus security profile that may be reflective of a state within a computer environment.

In some embodiments, an unlabeled data point is a candidate data point from which an active testing framework may sample for training or evaluating a machine learning model. In some examples, the unlabeled data point may be annotated to perform one or more subsequent training or evaluation operations. Due to constrained resources, some techniques of the present disclosure may sample a limited set of unlabeled data points, from the training dataset 402, that are representative of the training dataset 402 as a whole (e.g., without favoring a majority class). In addition, or alternatively, the unlabeled data points may be leveraged in a semi-supervised learning process in which both labeled and unlabeled datapoints may be simultaneously used during a training process.

In some embodiments, the computing system 101 generates a classification prompt 404 based on the unlabeled data point of the training dataset 402. The classification prompt 404 may comprise a binary classification prompt, a multi-class classification prompt, and/or the like. In some examples, the classification prompt may comprise a context element, an assertion element, and/or one or more instructions (e.g., binary classification or multi-class classification instructions).

In some embodiments, the classification prompt 404 comprises a generative model prompt that comprises instructions for generating a deterministic (e.g., a binary or categorical) response. The instructions, for example, may comprise binary classification instructions (e.g., instructing a true or false response), multi-class classification instructions (e.g., instructing one of multiple categorical classes), and/or the like from a generative model. The classification prompt 404, for example, may comprise structured data object that defines a classification task that may be consistently evaluated across different model architectures. In some examples, the classification prompt 404 may comprise an adaptive prompt that may be dynamically adjusted based on a model's performance and/or the specific characteristics of the input data. In addition, or alternatively, the classification prompt 404 may comprise one or more staged prompts. For example, the classification prompt 404 may be generated through a multi-stage prompting process in which a classification task may be broken down into a series of binary decisions to improve the accuracy, interpretability, and consistency of a model's outputs.

In some examples, the classification prompt 404 may comprise a structured data object (e.g., a text string) that combines context (e.g., a context element), a statement (e.g., an assertion element), and/or explicit instructions for a generative model to provide a classification response. The explicit instructions, for example, may define a classification task (e.g., binary, multi-class) with reference to a context element and/or an assertion element. The assertion element may comprise a statement that asserts a fact with respect to a context element. The context element, for example, may comprise content, such a text, imagery, audio, and/or the like, that may provide a basis for the assertion element. For instance, the context element may comprise an image, a text segments, and/or the like that may provide a basis for a fact asserted by the assertion element. By way of example, the context element may comprise an image and the assertion element may assert that an object is present within the image. As another example, the context element may comprise a document, set of text segments, and/or the like and the assertion element may assert an answer to a question based on the features expressed by the document, set of text segments, and/or the like. For instance, as a healthcare example, the context element may reflect an electronic health record, and the assertion element may assert a reason for a side effect within the electronic health record. As another example, in a computer security domain, the assertion element may reflect an activity log file, and the assertion element may assert a presence of a bug within the activity log file.

In some embodiments, an assertion element is derived from a question of an unlabeled data point. For example, the assertion element may be generated to convert an unlabeled question (e.g., a question without an answer) to an asserted fact that may be consistently assessed for accuracy across different model structures.

In some embodiments, the unlabeled data point comprises a question. The computing system 101 may generate a question prompt, based on the question, that comprises a context element and/or a question element. The computing system 101 may convert the unlabeled data point to a classification prompt 404 based on the question prompt. For example, the computing system 101 may generate, using a generative model (e.g., one of a generative model set 406), a generative response to the question based on the question prompt. The computing system 101 may generate the classification prompt 404 based on the question and the generative response. For example, the assertion element of the classification prompt 404 may be based on the generative response.

In some embodiments, a question comprises a component of one type of unlabeled data point for a question/answering (Q/A) task. The question, for example, may be combined with context to form the unlabeled data point. In some examples, the question may comprise an open ended query, a multi-choice question, and/or any other request for information. The question may comprise a structured or unstructured text string and/or data object. In some examples, it may comprise metadata, such as question type, domain classification, associated context references, and/or the like. In some examples, such as for multi-choice questions, the metadata may comprise one or more response constraints, such as one or more available responses and/or their relationships to the question.

In some embodiments, the question prompt comprises a generative model prompt that comprises instructions for generating a generative response that answers a question. The instructions, for example, may comprise Q/A instructions (e.g., instructing an open ended or constrained response), and/or the like for a generative model. The question prompt, for example, may comprise structured data object that defines a Q/A task that may be inconsistently evaluated across different model architectures due to deviations and/or an unconstrained (or excessive) range in possible outputs. In some examples, the question prompt may comprise an adaptive prompt that may be dynamically adjusted based on a model's performance and/or the specific characteristics of the input data. In addition, or alternatively, the question prompt may comprise one or more staged prompts. For example, the question prompt may be generated through a multi-stage prompting process in which a Q/A task may be broken down into a series of sub-questions to improve the accuracy, interpretability, and consistency of a model's outputs.

In some examples, the question prompt may comprise a structured data object (e.g., a text string) that combines context (e.g., a context element), a question (e.g., an assertion element), and/or explicit instructions for a generative model to provide a generative response. The explicit instructions, for example, may define a Q/A task with reference to a context element and/or a question element. The question element may comprise a statement that requests information with respect to a context element (e.g., the same context element of the classification prompt 404). The context element, for example, may comprise content, such as text, imagery, audio, and/or the like, that may provide a basis for the question element. For instance, the context element may comprise an image, a text segments, and/or the like that may provide information for answering a question asserted by the question element. By way of example, the context element may comprise an image and the question prompt may request whether a particular object is present within the image. As another example, the context element may comprise a document, set of text segments, and/or the like and the question element may request an answer to a question based on the features expressed by the document, set of text segments, and/or the like. For instance, as a healthcare example, the context element may reflect an electronic health record, and the question element may request a reason for a side effect within the electronic health record. As another example, in a computer security domain, the context element may reflect an activity log file, and the question element may request whether bug is present within the activity log file.

In some embodiments, the generative response is an open ended response to a question prompt that may vary in length and/or other characteristics. The generative response may comprise an output produced by a generative model in response to a given question and/or question prompt. A generative response, for example, may comprise a sequence of tokens, a structured text object, a binary classification, a multi-class classification, and/or the like. For example, the generative response may depend on the instructions and/or the question of the question prompt. For an open-ended question prompt, the generative response may comprise a sequence of tokens. In addition, or alternatively, for multiple choice questions, the generative response may comprise a categorical variable that corresponds to at least one class of the multiple choice questions. In this manner, the generative response may serve as a basis for creating an assertion element of a classification prompt 404, enabling the conversion of open-ended or multiple choice Q/A tasks into a format suitable for entropy-based evaluation and sampling, as described herein, regardless of the accuracy of the generative response (e.g., because entropy-based evaluation and sampling may focus on dispersion rather than accuracy).

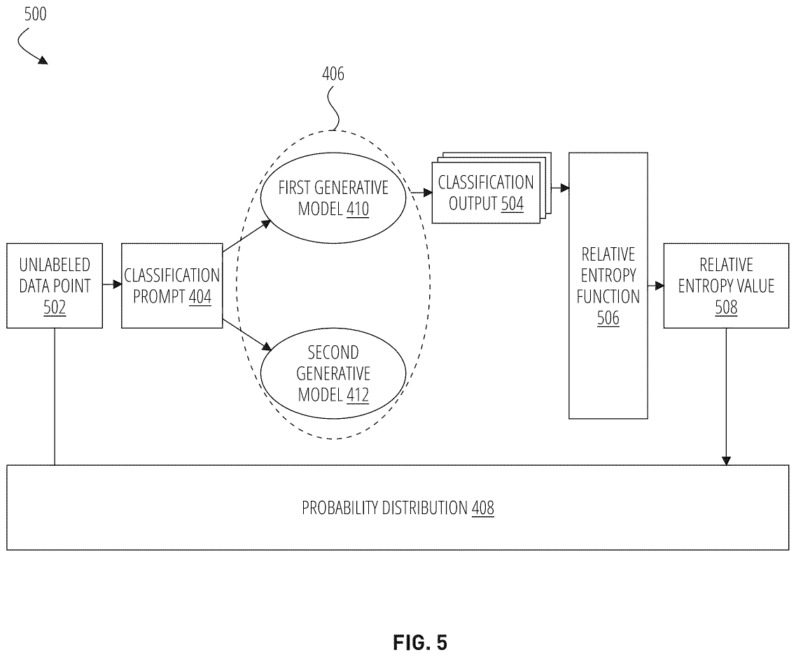

In some embodiments, the computing system 101 generates a set of classification outputs using a generative model set 406 and the classification prompt 404. As described herein with reference to FIG. 5, the computing system 101 may store up to each of the set of unlabeled data points within the training dataset 402 within a probability distribution 408 based on a relative entropy value derived from the set of classification outputs.

In some embodiments, the generative model set 406 comprises a collection of generative models that may be utilized for training and/or implementing the techniques of the present disclosure. A generative model set 406, for example, may comprise a diverse array of generative models, encompassing various model structures, architectures, sizes, and other attributes that may influence their performance and/or outputs relative to one another. By way of example, the generative model set 406 may comprise a first generative model 410, a second generative model 412, and/or any other number of other generative models. In some examples, the first generative model 410 may comprise a different model structure (e.g., size, architecture, training scheme, domain, capabilities) than the second generative model 412. In this manner, the computing system 101 may compare outputs from the same classification prompt 404 across multiple different model structures to overcome biases introduced through the unique model structures of individual generative models. This, in turn, enables the generation of a probability distribution 408 of unlabeled data points that is model agnostic, and may accurately model a true population within the training dataset 402 rather than a majority population. This approach enables more efficient and representative evaluation of generative models compared to traditional sampling approaches, such as random sampling.

More particularly, the generative model set 406 may comprise one or more different types of neural network architectures, such as transformer-based models, recurrent neural networks (RNNs), or other advanced architectures. In addition, or alternatively, the generative model set 406 may comprise one or more different model sizes (e.g., ten million parameters, two billion parameters, seven billion parameters), model capabilities (e.g., image processing, text processing, Q/A processing), and/or the like. In some examples, the generative model set 406 may be dynamically updated over time, incorporating new model architectures, fine-tuned versions of existing models, and/or the like, to continually improve the diversity and effectiveness of the active testing scheme 400. In addition, or alternatively, the generative model set 406 may be tailored to specific domains and/or tasks, such as medical Q/A in a clinical example, by comprising domain-specific pre-trained models alongside general-purpose language models.

In some embodiments, a generative model comprises any type of machine learning model, including language models, pre-trained transformers, and/or the like, that is configured, trained, and/or the like, to response to a structured prompt with a generative output. A generative model, for example, may comprise a machine learning model capable of generating new data instances in response to a model prompt (e.g., a classification prompt 404, question prompt)

A generative model may be implemented as a neural network, trained on large datasets using unsupervised and/or semi-supervised learning techniques, to learn the underlying patterns and distributions of the training data, enabling them to generate new, coherent outputs. In the context of natural language processing, generative models, such as GPT (Generative Pre-trained Transformer), BERT (Bidirectional Encoder Representations from Transformers), and/or the like, may be implemented using transformer architectures. These models utilize self-attention mechanisms and feed-forward neural networks to process and generate text. The self-attention mechanisms, and/or other components of a generative model may be configured, arranged, and/or modified in accordance with a model structure to improve model performance with respect to different computing tasks.

In some embodiments, a model structure defines a type of generative model and encompasses the model's architecture, size, training techniques, and/or any other components that may impact the operation of the model. The model structure, for example, may define the fundamental organization and characteristics of a generative model. From a technical perspective, a model structure may define various elements of a generative model, such as the number and/or arrangement of neural network layers, the types of activation functions used, the dimensionality of hidden states, the specific mechanisms employed for processing input data, and/or the like. For example, a transformer-based model structure may comprise multi-head attention layers, positional encodings, and feed-forward networks, while a recurrent neural network structure may utilize LSTM (Long Short-Term Memory), GRU (Gated Recurrent Unit) cells, and/or the like.

Regardless of the particular structure, a model structure may impact the behavior and capabilities of generative models within the generative model set 406. Different model structures, for example, may exhibit varying levels of performance and/or uncertainty on different types of tasks and/or datapoints. Some embodiments of the disclosure may leverage such deviations to create a more comprehensive annotated dataset 416 that may model a true population of a training dataset 402 as opposed to a portion of the training dataset 402 that is most influential on a single model structure. In some examples, a first generative model 410 and/or second generative model 412 may be selected based on their model structures. For example, a first generative model 410 and/or second generative model 412 may be selected for a particular iteration of the active testing scheme 400 to maximize and/or minimize their differences. In addition, or alternatively, hybrid model structures combining elements from different architectural paradigms may be explored to create more versatile and robust generative models for evaluation purposes.

In some embodiments, the probability distribution 408 comprises a distribution of datapoints that are positioned according to their relative entropy values. The probability distribution 408, for example, may represent a likelihood of selecting each unlabeled data point for annotation based on its informativeness for model evaluation. In some examples, the probability distribution 408 may comprise a normalized vector, function, and/or the like that assigns a probability value to up to each data point in an unlabeled dataset. This may be represented using various data structures, such as arrays, hash tables, or more specialized probabilistic data structures optimized for efficient sampling and updates.

In some examples, the computing system 101 may generate the probability distribution 408 by normalizing a relative entropy value for up to each unlabeled data point within the training dataset and mapping the unlabeled data points to a common distribution according to their normalized relative entropy values. In the context of the present disclosure, the probability distribution 408 may provide the basis for a strategic sampling process. For example, the probability distribution 408 may enable a selection of the most informative unlabeled data points from the training dataset based on their position within the probability distribution 408. This, in turn, may lead to the creation of a more effective and representative annotated dataset compared to traditional sampling approaches.

In some examples, the probability distribution 408 may comprise one or more different probability models, such as mixture models, hierarchical distributions, and/or the like, to capture complex patterns in the informativeness of data points. In addition, or alternatively, online learning techniques could be investigated to dynamically update the probability distribution as new annotations or model evaluations become available, allowing for adaptive sampling strategies that evolve over time.

In some embodiments, the computing system 101 generates an annotated dataset 416 by sampling the unlabeled data point from the probability distribution 408. For example, the computing system 101 may sample, using the probability distribution 408, a set of unlabeled data points from the training dataset 402 based on an annotation constraint. In some examples, the unlabeled data points may be sampled from the probability distribution 408 using a sampling function that samples a majority of a set of sampled data points from a portion of the probability distribution associated with at least one relative entropy value that meets or exceeds an entropy threshold.

In some embodiments, the sampling function comprises a data sampling approach for sampling data points from a distribution, such as the probability distribution 408. In some examples, the sampling function may prioritize data points with higher relative entropy values, enabling the selection of the most informative samples for annotation and evaluation. In some examples, the sampling function may be implemented as an algorithm that takes a probability distribution 408 as input and returns selected data points based on that distribution. This may involve various sampling techniques, such as probability sampling (e.g., simple random sampling from the probability distribution 408, systematic sampling, stratified sampling, cluster sampling), inverse transform sampling, rejection sampling, and/or the like.

In some examples, the sampling function may leverage a random number generator for traversing and/or selecting from complex probability distributions 408. The range of the random number generator may be modified for importance sampling to focus on high-probability regions, stratified sampling to ensure coverage across different parts of the probability distribution 408, Markov Chain Monte Carlo methods for sampling from high-dimensional distributions and/or the like. In some examples, parallel processing approaches may be employed to scale sampling operations to large datasets.

In some embodiments, an entropy threshold is defined to determine high uncertainty unlabeled data points relative to other unlabeled data points within the training dataset 402. The entropy threshold, for example, may comprise a relative and/or static indicator of a high relative entropy value within a probability distribution 408. The entropy threshold may serve as a cutoff point for determining which data points are considered highly informative and/or uncertain for the purposes of sampling and evaluation. In some examples, the entropy threshold may be implemented as a numerical value and/or function that defines a boundary in the space of relative entropy values. This may be a fixed scalar value, a percentile of the observed entropy distribution, and/or a more complex adaptive threshold based on the characteristics of the training dataset 402. In any form, an entropy threshold may be used to guide a sampling process, ensuring that a sufficient proportion of highly informative data points are selected for an annotated dataset 416. The entropy threshold, for example, may help balance the trade-off between exploring uncertain regions of the input space and exploiting known informative samples. Using the entropy threshold, the computing system 101 may sample from the probability distribution 408 by selecting the most uncertain samples more frequently while still giving a chance to lower entropy candidates. At the end of each sampling operation, when an unlabeled data point is selected, the selected sample may be removed from the candidates'pool and added to the annotated dataset 416.

In some embodiments, the computing system 101 generates a set of labels 414 respectively corresponding to the set of unlabeled data points to generate the annotated dataset 416. The annotated dataset 416, for example, may comprise a training or evaluation dataset that may be expanded through the active testing scheme 400 to support one or more downstream training or evaluation operations for one of the generative model set 406. For example, the annotated dataset 416 may comprise a collection of data points, where each data point may be paired with a corresponding label and/or annotation that provides ground truth information for a machine learning tasks. The labels 414 may be created through manual review by domain experts, through automated annotation pipelines, and/or the like based on the attributes of the unlabeled data point 502.

In some examples, the annotated dataset 416 may be stored in computer memory using structured data formats, such as JSON, CSV, or specialized database schemas that maintain the relationship between unlabeled data points 502 and their corresponding annotations. By way of example, the annotated dataset 416 may comprise a relational database with separate tables for data points and labels 414, a document-based database that stores complete annotated data points as individual documents, a graph data structure that stores labels 414 as an attribute of a graph node, and/or the like. The active testing pipeline may continuously expand the annotated dataset 416 by selecting new unlabeled data points for annotation from the training dataset 402, incorporating the resulting labels into the existing dataset structure, and storing the annotated data point within the annotated dataset 416. This expansion process may be managed through automated workflows that track annotation progress, validate label quality, and/or maintain data integrity throughout the annotation lifecycle. In some examples, the expansion process may be constrained by one or more annotation constraints.

In some embodiments, an annotation constraint may define one or more limitation on an annotated dataset 416. For instance, the annotation constraint may define a size constraint (e.g., maximum, minimum), a data type constraint, a relative distribution constraint, and/or the like for the annotated dataset 416. As one example, the annotation constraint may comprise a maximum size (e.g., K datapoints) constraint that places a practical limitation on a number of data points that may be labeled within a given project or evaluation framework. The maximum size constraint, for example, may be implemented to address resource limitations, such as computing system access restrictions (e.g., artificial agent access constraints), time constraints, and/or availability of processing and/or memory resources. In addition, or alternatively, the annotation constraint may comprise a model performance metric and/or the like that ties the annotated dataset 416 to a target model.

In some examples, an annotation constraint may be stored as a numerical parameter (e.g., K) within memory and may be used by sampling functions to determine when to terminate the sampling stage of the active testing scheme 400. The annotation constraint, for example, may comprise a configurable threshold value that may be adjusted based on annotation requirements and/or available computing resources (e.g., memory, processing time, artificial agent status). In this manner, the annotation constraint may provide a control mechanism in the active testing scheme 400 that ensures that the data selection process operates within predefined resource boundaries.

In some examples, the annotation constraint may be enforced through conditional logic that monitors the current size of the annotated dataset 416 against the maximum allowable size. The computing system 101 may continuously check the annotation constraint during the sampling stage of the active testing scheme 400 and prevent the selection of additional data points once the size of the annotated dataset 416 meets, exceeds, or is within a threshold distance of the annotation constraint. This functionality enables efficient resource allocation and improves computer scheduling operations for various machine learning tasks.

In some embodiments, the computing system 101 initiates an evaluation and/or training operation for a target model based on the annotated dataset 416. The target model, for example, may be one of the generative model set 406. In some examples, the target model may comprise a Q/A generative model. In addition, or alternatively, the target model may comprise a pre-trained generative classifier.

In some embodiments, the target model comprises a generative model, or any other model, that is trained or evaluated using the annotated dataset 416. The target model, for example, may be the subject of an iteration of the active testing scheme 400. For instance, the target model may comprise a generative model from the generative model set 406 that may be involved (e.g., the first generative model 410 or second generative model 412) and/or uninvolved with the active testing scheme 400. Regardless of its involvement in the active testing scheme 400, the target model may be trained, evaluated, or finetuned using the set of data point within the annotated dataset 416. In this regard, the target model may be configured in accordance with various generative tasks, such as question answering, text generation, classification, and/or the like, based on the training it receives from the annotated dataset 416.

In some embodiments, the target model is a pre-trained generative classifier. The pre-trained generative classifier may comprise a type of generative model, such as a foundational model, that may be pre-trained on a domain agnostic training corpus. The pre-trained generative classifier, for example, may comprise a foundational model that may be finetuned for a specific task. For example, the pre-trained generative classifier may leverage transfer learning to adapt a general-purpose language model to perform well on targeted classification tasks.

In addition, or alternatively, the target model may comprise question/answering (Q/A) generative model. The Q/A generative model may comprise a generative model that is trained for a question answering task. This type of model is designed to understand and respond to questions based on given context and/or knowledge. In some examples, the Q/A generative model may be implemented using a neural network-based architecture, such as a transformer-based model, due to their strong performance in natural language understanding and/or generation tasks. These models are trained on large datasets of question-answer pairs, potentially augmented with additional contextual information. By way of example, a Q/A generative model may comprise hybrid architectures that combine generative and extractive question answering techniques, or models that incorporate structured knowledge representations to improve reasoning capabilities. In addition, or alternatively, a multi-modal Q/A model may process and/or generate responses based on text, visual information, and/or the like.

In some embodiments, the computing system 101 initiates an evaluation operation to generate a performance metric 418 for at least one of the generative models within the generative model set 406. The performance metric 418, for example, may comprise any machine learning model performance measurement, such as classifier-based performance metrics (e.g., accuracy, confusion matrix, log-loss, AUC-ROC, cross-entropy) that measure an accuracy, recall, and/or precision of a generative classification model. In addition, or alternatively, the performance metric 418 may comprise a generative metrics, such as reconstruction scores, inception scores, Fréchet Inception Distances, rouge scores, F1-scores, and/or the like.

In addition, or alternatively, the computing system 101 may initiate a training operation based on the annotated dataset 416. The training operation, for example, may comprise a task-specific finetuning operation for a task associated with the training dataset 402.

In some embodiments, the training operation comprises a training and/or finetuning operation for configuring a machine learning model for a particular task. The training operation may encompass the computational process of adjusting model parameters to optimize performance on a specific dataset and/or task domain. By way of example, the training operation may comprise a supervised, reinforcement, and/or any other learning approach (e.g., backpropagation of errors as optimized using gradient descent and a task-specific function) to train the target model based on annotated examples from the annotated dataset 416. In some examples, the training operation may incorporate an active testing pipeline, where the target model may be iteratively trained using targeted feedback to sampled unlabeled data points over time.

In some embodiments, a task-specific finetuning operation may comprise a training operation used to finetune a pre-trained transformer for a particular task. A task-specific finetuning operation, for example, may implement a transfer learning pipeline where the target model may be pre-trained on a large, general-purpose dataset and/or then further trained on a smaller, domain-specific dataset to adapt its capabilities for a particular task. In such a case, the annotated dataset 416 may comprise the domain-specific dataset for the particular task. The task-specific finetuning operation, for example, may leverage the general language understanding and representation capabilities learned during pre-training while specializing the model's behavior for specific applications using sampled datapoints from the training dataset 402. In this manner, the active testing scheme 400 of the present disclosure may improve the training efficiencies of machine learning models by sampling highly information and unbiased data points from an original training dataset 402.

FIG. 5 is a dataflow diagram of a model-agnostic measurement scheme 500 in accordance with some embodiments of the present disclosure. A computing system, such as the computing system 101, may execute the model-agnostic measurement scheme 500 to address data sampling challenges introduced by structural differences between machine learning models. To do so, the computing system 101, and/or another system, may implement a relative entropy function 506 that measures a relative entropy value 508 between one or more different model structures (e.g., the first generative model 410, the second generative model 412) with respect to a single unlabeled data point 502. Unlike loss functions (e.g., cross-entropy loss), the relative entropy function 506 of the present disclosure may synthesize confidence values from different machine learning architecture. In this way, the relative entropy function 506 may reduce noise, traditionally introduced by model structures, in uncertainty measures to derive a true uncertainty with respect to an unlabeled data point 502. This, in turn, improves the accuracy, applicability, and generalizability of certainty measures, which may lead to improved model, and data point, analysis. Ultimately, by doing so, the model-agnostic measurement scheme 500 enables improved data sampling operations, which may be integrated within the active testing scheme 400 of FIG. 4 to improve generative model evaluation and performance in terms of various performance metrics (e.g., bias control, accuracy).

In some embodiments, the computing system 101 receives an unlabeled data point 502 from a training dataset 402. The unlabeled data point 502 may comprise a question, a text segment, and/or any other type of content, as described herein. In some examples, the computing system 101 may perform the model-agnostic measurement scheme 500 for up to each unlabeled data point 502 of a training dataset to map the unlabeled data points to a probability distribution 408 for use by the active testing scheme 400 described with reference to FIG. 4.

In some embodiments, the computing system 101 receives, using the generative model set 406, a set of classification outputs 504 for the unlabeled data point 502 within a training dataset. As described herein, the generative model set 406 may comprise (a) a first generative model 410 with a first model structure and/or (b) a second generative model 412 with a second model structure. In some examples, the first model structure may be different than the second model structure. The set of classification outputs 504 may comprise (a) a first classification output generated by the first generative model 410 based on the classification prompt 404 and/or a second classification output generated by the second generative model 412 based on the classification prompt 404.

In some embodiments, a classification output of the set of classification outputs 504 comprises a deterministic or probabilistic output generated by a generative model (e.g., the first generative model 410, second generative model 412) based on a classification prompt 404. Up to each of the classification outputs 504 may indicate a predicted class for the classification prompt 404. The classification outputs 504, for example, may comprise a discrete label, binary value, probabilistic value (e.g., within a range of 0-1), a probability array over a predefined set of classes, and/or the like. In some examples, the form of the classification outputs 504 may depend on the classification prompt 404. For example, a binary classification prompt may result in a binary or probabilistic classification output. In addition, or alternatively, a multi-class classification prompt may result in a discrete label or probability array. In any form, each of the classification outputs may be comparable across generative models. In this manner, the classification output 504 may provide a standardized format for comparing model predictions across different architectures and/or data point types.

Up to each of the set of classification outputs 504 may be generated by a generative model of the generative model set 406 based on the classification prompt 404. In some examples, each classification output 504 may be generated using the same classification prompt 404. In addition, or alternatively, one or more modifications may be made to the classification prompt 404 to address one or more structural differences between the first generative model 410 and/or second generative model 412.

In some embodiments, a class is one of one or more defined classes within a classification task. A class, for example, may comprise one of two classes (e.g., positive or negative) in a binary classification task, or one of a set of categorical classes in a multi-class classification task. In some examples, a class may be represented as a discrete label and/or identifier within the computing system 101. In binary classification, for example, classes may be encoded as 0 and 1 or −1 and 1. In addition, or alternatively, in multi-class classification, the classes may be encoded as integer indices, string labels, and/or the like to represent multiple, distinct categories. In some examples, the defined classes of the present disclosure may provide a consistent evaluation term for classification outputs 504 derived from different unlabeled data points and/or generative models.

In some embodiments, the computing system 101 generates, using a relative entropy function 506, a relative entropy value 508 for the unlabeled data point 502. The relative entropy value 508, for example, may be based on a confidence value associated with the first classification output and/or the second classification output from the first generative model 410 and second generative model 412. In some examples, the confidence value may comprise a first entropy estimate for a class of the first classification output. The relative entropy function 506 may compare the confidence value to a second entropy estimate for the class of the second classification output.

In some embodiments, the classification outputs 504 (e.g., the first classification output and/or the second classification output) comprise a binary output associated with a positive class and a negative class. The relative entropy value 508 for the unlabeled data point 502 may be based on (i) a first positive confidence value of the first generative model 410 for the positive class based on the classification prompt 404, (ii) a second positive confidence value of the second generative model 412 for the positive class based on the classification prompt 404, (iii) a first negative confidence value of the first generative model 410 for the negative class based on the classification prompt 404, and/or (iv) a second negative confidence value of the second generative model 412 for the negative class based on the classification prompt 404. By way of example, the relative entropy function 506 may generate (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and/or (iii) the relative entropy value 508 based on the relative positive entropy estimate and the relative negative entropy estimate.

More particularly, in some embodiments, the relative entropy function 506 comprises a model agnostic confidence assessment mechanism for identifying the relative entropy of an unlabeled data point 502 that reduces structure related biases. The relative entropy function 506, for example, may provide a measure of uncertainty or information content based on the classification output 504 of one or multiple generative models.

In some embodiments, the relative entropy function 506 may comprise a single model acquisition function that generates a relative entropy value 508 for the second generative model 412 (e.g., a target model in this case) based on the classification outputs 504 of the first generative model 410. For example, by constraining the classes for each unlabeled data point 502, the relative entropy function 506 may retrieve the confidence values of each output class (e.g., Yes/No in the binary classification use case) directly from the first generative model 410 (e.g., p (Yes|<context element, assertion element>) and p (No|<context element, assertion element>)). In some examples, the confidence values may be extracted using model-specific APIs. The relative entropy function 506 may determine the relative entropy value, H, for the unlabeled data point using these class-wise confidence values. By way of example, a single model acquisition function for a binary classification use case may be defined as:
H=−p(Yes|<context element, assertion element>) log p(Yes|<context element, assertion element>)−p(No|<context element, assertion element>) log p(No|<context element, assertion element>)
   where p(Yes|<context element, assertion element>) may comprise a class-wise confidence value for the positive class, −p(Yes|<context element, assertion element>) log p(Yes|<context element, assertion element>) may comprise a relative positive entropy estimate, p(No|<context element, assertion element>) may comprise a class-wise confidence value for a negative class, and −p(No|<context element, assertion element>) log p(No|<context element, assertion element>) may comprise a relative negative entropy estimate.

In some embodiments, the relative entropy function 506 may comprise a multi-model acquisition function that generates a relative entropy value 508 for the second generative model 412, the first generative model 410, or any other generative model within the generative model set 406 based on the classification outputs 504 of both the first generative model 410 and the second generative model 412 (and any other generative model within the generative model set 406 as the number of models used is not limited). For example, using only a single generative model may limit the diversity of samples selected from the probability distribution 408. Through active testing, the computing system 101 may aim to select subsets that cover a variety of different error types or patterns in a model's predictions. Just acquiring samples with the highest predictive entropy at all steps may not guarantee diversity. To address this challenge, the multi-model acquisition function may leverage the relative entropy of at least two generative models for diverse sample selection. The probabilities of the two generative models, for example, may be denoted by p (e.g., first generative model 410) and q (e.g., second generative model 412). A multi-model acquisition function for a binary classification use case may be defined as:
H=−p(Yes|<context element, assertion element>) log q(Yes|<context element, assertion element>)−p(No|<context element, assertion element>) log q(No|<context element, assertion element>)
   where p(Yes|<context element, assertion element>) may comprise a class-wise confidence value for the positive class, −p(Yes|<context element, assertion element>) log q(Yes|<context element, assertion element>) may comprise a relative positive entropy estimate, p(No|<context element, assertion element>) may comprise a class-wise confidence value for a negative class, and −p(No|<context element, assertion element>) log q(No|<context element, assertion element>) may comprise a relative negative entropy estimate. By combining confidence values from multiple generative models, the relative entropy function 506 may measure a relative uncertainty, rather than a model-specific uncertainty with respect to a data point. In this way, the relative entropy function 506 may be leveraged to prioritize unlabeled data points where multiple models are uncertain, relative to other cases where one model is uncertain.

In some embodiments, the confidence value comprises a measure of certainty of a generative model in a model output, such as the classification outputs 504. The confidence value, for example, may comprise an entropy estimate or other quantitative representation of the model's certainty in its prediction or generation. In some examples, the confidence values of the present disclosure may be class specific. For instance, the confidence values may comprise class-wise confidence values for a classification output of a particular class (e.g., class-wise confidence values for the positive class or negative class of a binary classification task).

A confidence value may comprise a numerical (e.g., real number) or probabilistic (e.g., between 0 and 1, 1 and 1) score. In some examples, the score may be derived from a generative model's internal representations, such as softmax probabilities in classification tasks or perplexity measures in language generation tasks. In some examples, a confidence value may be extracted and/or processed using one or more signals from the model's computational graph. By way of example, a confidence value may be determined using temperature scaling for calibrating raw model outputs, ensemble methods for aggregating confidence estimates across multiple model runs, or Bayesian approaches for capturing uncertainty in model parameters. In some examples, a confidence value may be normalized and/or standardized across different model architectures or output types to enable consistent comparisons within the relative entropy function 506.

In some embodiments, the relative entropy function 506 generates the relative entropy value 508 by synthesizing a relative positive entropy estimate and/or relative negative entropy estimate.

The relative positive entropy estimate, for example, may comprise a component of the relative entropy value 508 that measures a relative measure of confidence for a positive class with respect to a particular unlabeled data point 502. The relative positive entropy estimate, for example, may be derived from one or more class-specific confidence values for a positive class. In some examples, the class-specific confidence values may be aggregated from multiple, different machine learning models (e.g., the first generative model 410, the second generative model 412) to quantify the degree of agreement and/or disagreement among models regarding a positive classification of the unlabeled data point 502.

The relative negative entropy estimate, for example, may comprise a component of the relative entropy value 508 that measures a relative measure of confidence for a negative class with respect to a particular unlabeled data point 502. The relative negative entropy estimate, for example, may be derived from one or more class-specific confidence values for a negative class. In some examples, the class-specific confidence values may be aggregated from multiple, different machine learning models (e.g., the first generative model 410, the second generative model 412) to quantify the degree of agreement and/or disagreement among models regarding a negative classification of the unlabeled data point 502.

In some embodiments, the relative entropy value 508 comprises a model agnostic confidence measure that measures a generalized model confidence with respect to a particular data point. The relative entropy function 506, for example, may provide a single scalar value representing an overall uncertainty and/or disagreement among one or multiple models for an unlabeled data point 502. For example, the relative entropy value may synthesize information from positive and negative entropy estimates (e.g., relative positive entropy estimate, relative negative entropy estimate), and/or directly compute a divergence measure between the outputs of multiple models.

In some examples, the computing system 101 may normalize the relative entropy value 508 to align the relative entropy value 508 within the probability distribution 408. For example, the computing system 101 may normalize the relative entropy value 508 to one to create a probabilistic value that may be mapped within the classification prompt 404 relative to one or more other relative entropy values. In some embodiments, the computing system 101 stores (e.g., in normalized of unnormalized form) the unlabeled data point 502 within the probability distribution 408 based on the relative entropy value 508, as described with reference to FIG. 4.

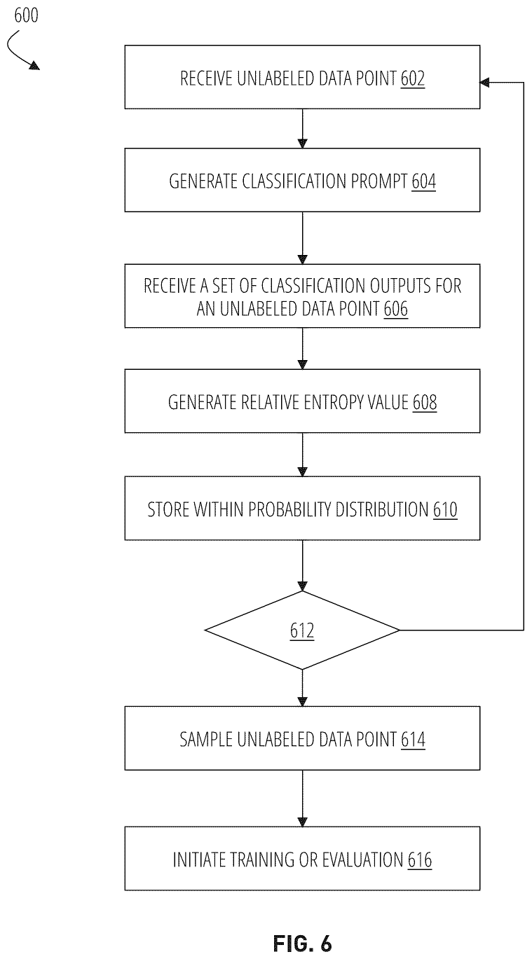

FIG. 6 is a flowchart diagram of an example active testing process 600 in accordance with some embodiments of the present disclosure. The flowchart diagram depicts an active testing technique that applies an unbiased data sampling approach to improve machine learning technology. The active testing process 600 may be implemented by one or more computing devices, entities, and/or systems described herein. For example, via the various steps/operations of the active testing process 600, the computing system 101 may generate an improved annotated dataset for training and evaluation machine learning model performance. By doing so, the active testing process 600 may improve computer functionality by improving generative model performance (e.g., in terms of evaluation, bias, accuracy).

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving an unlabeled data point from a training dataset. For example, the computing system 101 may receive the unlabeled data point. In some examples, the unlabeled data point may comprise a question.

In some embodiments, the process 600 comprises, at operation 604, generating classification prompt. For example, the computing system 101 may generate a question prompt based on the question. The computing system 101 may generate, using a generative model, a generative response to the question based on the question prompt. The computing system 101 may generate the classification prompt based on the question and/or the generative response. In some example, the classification prompt may comprise a binary classification prompt. The question prompt may comprise a context element and/or a question element, and the binary classification prompt may comprise the context element and an assertion element that is based on the generative response.

In some embodiments, the process 600 comprises, at operation 606, receiving a set of classification outputs for the unlabeled data point. For example, the computing system 101 may receive, using a generative model set, a set of classification outputs for an unlabeled data point within a training dataset. For example, the generative model set may comprise (a) a first generative model with a first model structure and/or (b) a second generative model with a second model structure. In some examples, the set of classification outputs may comprise (a) a first classification output generated by the first generative model based on a classification prompt and/or a second classification output generated by the second generative model based on the classification prompt. In some examples, the first model structure is different than the second model structure.

In some embodiments, the process 600 comprises, at operation 608, generating a relative entropy value. For example, the computing system 101 may generate, using a relative entropy function, a relative entropy value for the unlabeled data point based on a confidence value associated with the first classification output or the second classification output. In some examples, the confidence value may comprise a first entropy estimate for a class of the first classification output. The relative entropy function may compare the confidence value to a second entropy estimate for the class of the second classification output.

In some embodiments, the classification outputs (e.g., the first classification output and/or the second classification output) comprise a binary output associated with a positive class and a negative class. The relative entropy value for the unlabeled data point may be based on (i) a first positive confidence value of the first generative model for the positive class based on the classification prompt, (ii) a second positive confidence value of the second generative model for the positive class based on the classification prompt, (iii) a first negative confidence value of the first generative model for the negative class based on the classification prompt, and/or (iv) a second negative confidence value of the second generative model for the negative class based on the classification prompt. By way of example, the relative entropy function may generate (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and/or (iii) the relative entropy value based on the relative positive entropy estimate and the relative negative entropy estimate.

In some embodiments, the process 600 comprises, at operation 610, storing the unlabeled data point within a probability distribution based on the relative entropy value. For example, the computing system 101 may store the unlabeled data point within a probability distribution based on the relative entropy value.

In some embodiments, the process 600, at operation 612, may return to operation 602 to receive another unlabeled data point from the training dataset. In the event that a threshold is reached (e.g., all or a threshold number of data points within training dataset 402 have been assessed), the process 600 may proceed to operation 614.

In some embodiments, the process 600 comprises, at operation 614, sampling unlabeled data points from probability distribution. For example, the computing system 101 may generate an annotated dataset by sampling the unlabeled data point from the probability distribution. In some examples, the unlabeled data point may be sampled from the probability distribution using a sampling function that samples a majority of a set of sampled data points from a portion of the probability distribution associated with at least one relative entropy value that meets or exceeds an entropy threshold. In some examples, the computing system 101 samples, using the probability distribution, a set of unlabeled data points from the training dataset based on an annotation constraint. The computing system 101 may generate a set of labels respectively corresponding to the set of unlabeled data points.

In some embodiments, the process 600 comprises, at operation 616, training or evaluating a generative model based on the sampled data points. For example, the computing system 101 may initiate a training operation for a target model based on the annotated dataset. In some examples, the target model may comprise a Q/A generative model. In addition, or alternatively, the target model may comprise a pre-trained generative classifier. The training operation may comprise a task-specific finetuning operation for a task associated with the training dataset.

Some techniques of the present disclosure enable the generation of action outputs that may be performed to initiate one or more real world actions to achieve real-world effects. The techniques of the present disclosure may be used, applied, and/or otherwise leveraged to improve generative processes. In some examples, the outputs of the downstream generative processes of the present disclosure may trigger action outputs (e.g., through control instructions) to automate various actions, such as robotic actions, computer security actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors and using a generative model set, a set of classification outputs for an unlabeled data point within a training dataset, wherein (i) the generative model set comprises (a) a first generative model with a first model structure and (b) a second generative model with a second model structure, (ii) the set of classification outputs comprises (a) a first classification output generated by the first generative model based on a classification prompt and (b) a second classification output generated by the second generative model based on the classification prompt, and (iii) the first model structure is different than the second model structure; generating, by the one or more processors and using a relative entropy function, a relative entropy value for the unlabeled data point based on a confidence value associated with the first classification output or the second classification output; storing, by the one or more processors, the unlabeled data point within a probability distribution based on the relative entropy value; generating, by the one or more processors, an annotated dataset by sampling the unlabeled data point from the probability distribution; and initiating, by the one or more processors, a training operation for a target model based on the annotated dataset.

Example 2. The computer-implemented method of example 1, wherein the target model comprises a question/answering (Q/A) generative model, the unlabeled data point comprises a question, the classification prompt comprises a binary classification prompt, and the computer-implemented method further comprises generating a question prompt based on the question; generating, using a generative model, a generative response to the question based on the question prompt; and generating the binary classification prompt based on the question and the generative response.

Example 3. The computer-implemented method of example 2, wherein the question prompt comprises a context element and a question element, and the binary classification prompt comprises the context element and an assertion element that is based on the generative response.

Example 4. The computer-implemented method of any of the preceding examples, wherein the confidence value comprises a first entropy estimate for a class of the first classification output, and the relative entropy function compares the confidence value to a second entropy estimate for the class of the second classification output.

Example 5. The computer-implemented method of any of the preceding examples, wherein the first classification output and the second classification output comprise a binary output associated with a positive class and a negative class.

Example 6. The computer-implemented method of example 5, wherein the relative entropy value for the unlabeled data point is based on (i) a first positive confidence value of the first generative model for the positive class based on the classification prompt, (ii) a second positive confidence value of the second generative model for the positive class based on the classification prompt, (iii) a first negative confidence value of the first generative model for the negative class based on the classification prompt, and (iv) a second negative confidence value of the second generative model for the negative class based on the classification prompt.

Example 7. The computer-implemented method of example 6, wherein the relative entropy function generates (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and (iii) the relative entropy value based on the relative positive entropy estimate and the relative negative entropy estimate.

Example 8. The computer-implemented method of any of the preceding examples, wherein the unlabeled data point is sampled from the probability distribution using a sampling function that samples a majority of a set of sampled data points from a portion of the probability distribution associated with at least one relative entropy value that meets or exceeds an entropy threshold.

Example 9. The computer-implemented method of any of the preceding examples, wherein generating the annotated dataset comprises sampling, using the probability distribution, a set of unlabeled data points from the training dataset based on an annotation constraint; and generating a set of labels respectively corresponding to the set of unlabeled data points.

Example 10. The computer-implemented method of any of the preceding examples, wherein the target model comprises a pre-trained generative classifier, and the training operation comprises a task-specific finetuning operation for a task associated with the training dataset.

Example 11. A system comprising one or more processors; and one or more memories storing processor-executable instructions that, when executed by the one or more processors, cause the one or more processors to perform operations comprising receiving, using a generative model set, a set of classification outputs for an unlabeled data point within a training dataset, wherein (i) the generative model set comprises (a) a first generative model with a first model structure and (b) a second generative model with a second model structure, (ii) the set of classification outputs comprises (a) a first classification output generated by the first generative model based on a classification prompt and (b) a second classification output generated by the second generative model based on the classification prompt, and (iii) the first model structure is different than the second model structure; generating, using a relative entropy function, a relative entropy value for the unlabeled data point based on a confidence value associated with the first classification output or the second classification output; storing the unlabeled data point within a probability distribution based on the relative entropy value; generating an annotated dataset by sampling the unlabeled data point from the probability distribution; and initiating a training operation for a target model based on the annotated dataset.

Example 12. The system of example 11, wherein the target model comprises a question/answering (Q/A) generative model, the unlabeled data point comprises a question, the classification prompt comprises a binary classification prompt, and the operations further comprise generating a question prompt based on the question; generating, using a generative model, a generative response to the question based on the question prompt; and generating the binary classification prompt based on the question and the generative response.

Example 13. The system of example 12, wherein the question prompt comprises a context element and a question element, and the binary classification prompt comprises the context element and an assertion element that is based on the generative response.

Example 14. The system of any of examples 11 through 13, wherein the confidence value comprises a first entropy estimate for a class of the first classification output, and the relative entropy function compares the confidence value to a second entropy estimate for the class of the second classification output.

Example 15. The system of any of examples 11 through 14, wherein the first classification output and the second classification output comprise a binary output associated with a positive class and a negative class.

Example 16. The system of example 15, wherein the relative entropy value for the unlabeled data point is based on (i) a first positive confidence value of the first generative model for the positive class based on the classification prompt, (ii) a second positive confidence value of the second generative model for the positive class based on the classification prompt, (iii) a first negative confidence value of the first generative model for the negative class based on the classification prompt, and (iv) a second negative confidence value of the second generative model for the negative class based on the classification prompt.

Example 17. The system of example 16, wherein the relative entropy function generates (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and (iii) the relative entropy value based on the relative positive entropy estimate and the relative negative entropy estimate.

Example 18. One or more non-transitory computer-readable media storing processor-executable instructions that, when executed by one or more processors, cause the one or more processors to perform operations comprising receiving, using a generative model set, a set of classification outputs for an unlabeled data point within a training dataset, wherein (i) the generative model set comprises (a) a first generative model with a first model structure and (b) a second generative model with a second model structure, (ii) the set of classification outputs comprises (a) a first classification output generated by the first generative model based on a classification prompt and (b) a second classification output generated by the second generative model based on the classification prompt, and (iii) the first model structure is different than the second model structure; generating, using a relative entropy function, a relative entropy value for the unlabeled data point based on a confidence value associated with the first classification output or the second classification output; storing the unlabeled data point within a probability distribution based on the relative entropy value; generating an annotated dataset by sampling the unlabeled data point from the probability distribution; and initiating a training operation for a target model based on the annotated dataset.

Example 19. The one or more non-transitory computer-readable media of example 18, wherein the unlabeled data point is sampled from the probability distribution using a sampling function that samples a majority of a set of sampled data points from a portion of the probability distribution associated with at least one relative entropy value that meets or exceeds an entropy threshold.

Example 20. The one or more non-transitory computer-readable media of any of examples 18 through 19, wherein generating the annotated dataset comprises sampling, using the probability distribution, a set of unlabeled data points from the training dataset based on an annotation constraint; and generating a set of labels respectively corresponding to the set of unlabeled data points.

Example 21. The computer-implemented method of example 1, wherein the method further comprises training the first generative model, the second generative model, or the target model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the first generative model, the second generative model, or the target model.

Example 25. The computing system of example 24, wherein the one or more processors are comprised in a first computing entity; and the first generative model, the second generative model, or the target model is trained by one or more other processors comprised in a second computing entity.

Example 26. The one or more non-transitory computer-readable storage media of example 18, wherein the instructions further cause the one or more processors to train the first generative model, the second generative model, or the target model.

Example 27. The one or more non-transitory computer-readable storage media of example 26, wherein the one or more processors are comprised in a first computing entity; and the first generative model, the second generative model, or the target model is trained by one or more other processors comprised in a second computing entity.

What is claimed is:

1. A computer-implemented method comprising:
receiving, by one or more processors and using a generative model set, a set of classification outputs for an unlabeled data point within a training dataset, wherein:
(i) the generative model set comprises (a) a first generative model with a first model structure and (b) a second generative model with a second model structure,
(ii) the set of classification outputs comprises (a) a first classification output generated by the first generative model based on a classification prompt and (b) a second classification output generated by the second generative model based on the classification prompt, and
(iii) the first model structure is different than the second model structure;
generating, by the one or more processors and using a relative entropy function, a relative entropy value for the unlabeled data point based on a confidence value associated with the first classification output or the second classification output;
storing, by the one or more processors, the unlabeled data point within a probability distribution based on the relative entropy value;
generating, by the one or more processors, an annotated dataset by sampling the unlabeled data point from the probability distribution; and
initiating, by the one or more processors, a training operation for a target model based on the annotated dataset.

2. The computer-implemented method of claim 1, wherein the target model comprises a question/answering (Q/A) generative model, the unlabeled data point comprises a question, the classification prompt comprises a binary classification prompt, and the computer-implemented method further comprises:
generating a question prompt based on the question;
generating, using a generative model, a generative response to the question based on the question prompt; and
generating the binary classification prompt based on the question and the generative response.

3. The computer-implemented method of claim 2, wherein the question prompt comprises a context element and a question element, and the binary classification prompt comprises the context element and an assertion element that is based on the generative response.

4. The computer-implemented method of claim 1, wherein the confidence value comprises a first entropy estimate for a class of the first classification output, and the relative entropy function compares the confidence value to a second entropy estimate for the class of the second classification output.

5. The computer-implemented method of claim 1, wherein the first classification output and the second classification output comprise a binary output associated with a positive class and a negative class.

6. The computer-implemented method of claim 5, wherein the relative entropy value for the unlabeled data point is based on:
(i) a first positive confidence value of the first generative model for the positive class based on the classification prompt,
(ii) a second positive confidence value of the second generative model for the positive class based on the classification prompt,
(iii) a first negative confidence value of the first generative model for the negative class based on the classification prompt, and
(iv) a second negative confidence value of the second generative model for the negative class based on the classification prompt.

7. The computer-implemented method of claim 6, wherein the relative entropy function generates (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and (iii) the relative entropy value based on the relative positive entropy estimate and the relative negative entropy estimate.

8. The computer-implemented method of claim 1, wherein the unlabeled data point is sampled from the probability distribution using a sampling function that samples a majority of a set of sampled data points from a portion of the probability distribution associated with at least one relative entropy value that meets or exceeds an entropy threshold.

9. The computer-implemented method of claim 1, wherein generating the annotated dataset comprises:
sampling, using the probability distribution, a set of unlabeled data points from the training dataset based on an annotation constraint; and
generating a set of labels respectively corresponding to the set of unlabeled data points.

10. The computer-implemented method of claim 1, wherein the target model comprises a pre-trained generative classifier, and the training operation comprises a task-specific finetuning operation for a task associated with the training dataset.

11. A system comprising:
one or more processors; and
one or more memories storing processor-executable instructions that, when executed by the one or more processors, cause the one or more processors to perform operations comprising:
receiving, using a generative model set, a set of classification outputs for an unlabeled data point within a training dataset, wherein:
(i) the generative model set comprises (a) a first generative model with a first model structure and (b) a second generative model with a second model structure,
(ii) the set of classification outputs comprises (a) a first classification output generated by the first generative model based on a classification prompt and (b) a second classification output generated by the second generative model based on the classification prompt, and
(iii) the first model structure is different than the second model structure;
generating, using a relative entropy function, a relative entropy value for the unlabeled data point based on a confidence value associated with the first classification output or the second classification output;
storing the unlabeled data point within a probability distribution based on the relative entropy value;
generating an annotated dataset by sampling the unlabeled data point from the probability distribution; and
initiating a training operation for a target model based on the annotated dataset.

12. The system of claim 11, wherein the target model comprises a question/answering (Q/A) generative model, the unlabeled data point comprises a question, the classification prompt comprises a binary classification prompt, and the operations further comprise:
generating a question prompt based on the question;
generating, using a generative model, a generative response to the question based on the question prompt; and
generating the binary classification prompt based on the question and the generative response.

13. The system of claim 12, wherein the question prompt comprises a context element and a question element, and the binary classification prompt comprises the context element and an assertion element that is based on the generative response.

14. The system of claim 11, wherein the confidence value comprises a first entropy estimate for a class of the first classification output, and the relative entropy function compares the confidence value to a second entropy estimate for the class of the second classification output.

15. The system of claim 11, wherein the first classification output and the second classification output comprise a binary output associated with a positive class and a negative class.

16. The system of claim 15, wherein the relative entropy value for the unlabeled data point is based on:
(i) a first positive confidence value of the first generative model for the positive class based on the classification prompt,
(ii) a second positive confidence value of the second generative model for the positive class based on the classification prompt,
(iii) a first negative confidence value of the first generative model for the negative class based on the classification prompt, and
(iv) a second negative confidence value of the second generative model for the negative class based on the classification prompt.

17. The system of claim 16, wherein the relative entropy function generates (i) a relative positive entropy estimate based on the first positive confidence value and a logarithmic derivative of the second positive confidence value, (ii) a relative negative entropy estimate based on the first negative confidence value and a logarithmic derivative of the second negative confidence value, and (iii) the relative entropy value based on the relative positive entropy estimate and the relative negative entropy estimate.

18. One or more non-transitory computer-readable media storing processor-executable instructions that, when executed by one or more processors, cause the one or more processors to perform operations comprising:
receiving, using a generative model set, a set of classification outputs for an unlabeled data point within a training dataset, wherein:
(i) the generative model set comprises (a) a first generative model with a first model structure and (b) a second generative model with a second model structure,
(ii) the set of classification outputs comprises (a) a first classification output generated by the first generative model based on a classification prompt and (b) a second classification output generated by the second generative model based on the classification prompt, and
(iii) the first model structure is different than the second model structure;
generating, using a relative entropy function, a relative entropy value for the unlabeled data point based on a confidence value associated with the first classification output or the second classification output;
storing the unlabeled data point within a probability distribution based on the relative entropy value;
generating an annotated dataset by sampling the unlabeled data point from the probability distribution; and
initiating a training operation for a target model based on the annotated dataset.

19. The one or more non-transitory computer-readable media of claim 18, wherein the unlabeled data point is sampled from the probability distribution using a sampling function that samples a majority of a set of sampled data points from a portion of the probability distribution associated with at least one relative entropy value that meets or exceeds an entropy threshold.

20. The one or more non-transitory computer-readable media of claim 18, wherein
generating the annotated dataset comprises:
sampling, using the probability distribution, a set of unlabeled data points from the training dataset based on an annotation constraint; and
generating a set of labels respectively corresponding to the set of unlabeled data points.
